(19) United States
(12) Patent Application Publication
(10) Pub. No.: US 2015/0004358 A1
(43) Pub. Date: Jan. 1, 2015

(54) FREE-STANDING POLYMER MEMBRANE HAVING THROUGH-HOLES AND METHOD FOR MANUFACTURING SAME

(71) Applicant: Wonjae Jung, Suwon-si (KR)

(72) Inventor: Wonjae Jung, Suwon-si (KR)

(21) Appl. No.: 14/377,878

(22) PCT Filed: Feb. 9, 2013
(86) PCT No.: PCT/KR2013/001053

§ 371 Date: Aug. 11, 2014

(30) Foreign Application Priority Data
Feb. 9, 2012 (KR) 10-2012-0013106

(51) Int. Cl. B29C 43/02

(52) U.S. Cl. CPC B29C 43/021; B29K 2101/00
USPC 428/131; 264/330

(57) ABSTRACT

Disclosed is a freestanding polymer membrane having through-holes, comprising at least one through-hole formation area having a plurality of through-holes formed at a predetermined distance and a support area formed around the through-hole formation area to be thicker than the through-hole formation area so as to support the through-hole formation area, the polymer membrane being freestanding without use of a separate substrate.

### TECHNICAL FIELD

The present invention relates to a freestanding polymer membrane having through-holes and a method of manufacturing the same, and more particularly, to a freestanding polymer membrane, which is configured to have fine through-holes and to be capable of maintaining a shape by itself without use of a separate substrate, and to a method of manufacturing the same.

### BACKGROUND ART

A conventional shadow mask is typically exemplified by a metal mask called FMM (Fine Metal Mask). This mask is mainly used in the selective deposition of an organic material in an OLED process, but problems occur in regard to decreasing the size of through-holes of FMM to increase the pixel size of a display. However, existing process techniques are limited to FMM having a size of tens of micrometers, thus making it difficult to manufacture a metal shadow mask having a size ranging from ones of micrometers to nanometers, and significantly increasing the manufacturing cost thereof. Hence, techniques for manufacturing a mask using a novel material are required.

Accordingly, research is recently ongoing into a nanostencil defined as a thin membrane having fine nanometer-sized through-holes. However, such nanostencils known to date are manufactured by a multilayer etching process of a semiconductor process using a silicon-based hard inorganic material. In particular, although nanometer-sized through-holes are processed using an E-beam process or a focused ion beam process, the process costs increase when forming fine through-holes over a large area. Thus, attempts have been made to manufacture a nanostencil comprising a polymer by means of a polymer forming process.

FIG. 1 illustrates a typical polymer forming process for manufacturing a nanostencil using a polymer.

As illustrated in FIG. 1, the polymer nanostencil 1 is manufactured using a mold 4 with protrusions 3 having a size of through-holes 2 to be processed. A non-traditional lithography process is useful for production of the nanostencil 1 using the polymer but is problematic because a residual layer 5 may be left behind under the processed pattern for through-holes 2. Despite the use of the non-traditional polymer process, which does not adopt a semiconductor process such as an imprinting process and a soft lithography process, the removal of the residual layer 5 always additionally requires a semiconductor process such as an etching process, and thus it is very difficult to manufacture the stencil using only the polymer process.

Furthermore, even when the residual layer 5 is removed using an etching process, it is considerably difficult to maintain the shape of the through-holes 2 and the membrane due to low rigidity of the polymer, and this problem may become severe with a reduction in the thickness of the membrane and the size of the through-holes 2.

Thus, the conventional polymer nanostencil 1 may be provided in the form of a thin membrane with the aid of a separate substrate such as a film, silicon or glass. To maintain the shape of the membrane by itself without use of a substrate, the use of an inorganic material such as silicon having higher rigidity than that of the polymer is favorable. For this reason, most of nanostencils manufactured to date include silicon-based inorganic stencils.

### DISCLOSURE

### Technical Problem

Accordingly, the present invention has been made keeping in mind the above problems encountered in the prior art, and an object of the present invention is to provide a freestanding polymer membrane, which is configured to have fine through-holes and to be capable of maintaining a shape by itself without use of a separate substrate.

Another object of the present invention is to provide a method of easily manufacturing a freestanding polymer membrane having through-holes, using only a polymer forming process without additional use of a semiconductor process.

### Technical Solution

An aspect of the present invention provides a freestanding polymer membrane having through-holes, comprising at least one through-hole formation area having a plurality of through-holes formed at a predetermined distance and a support area formed around the through-hole formation area to be thicker than the through-hole formation area so as to support the through-hole formation area, the polymer membrane being freestanding without use of a separate substrate.

Another aspect of the present invention provides a freestanding polymer membrane having through-holes, configured such that a plurality of fine nanometer-sized through-holes are formed at a bottom of at least one recess on a micrometer scale on any one side of the polymer membrane, the polymer membrane being freestanding without use of a separate support structure.

As such, the polymer membrane according to the present invention is preferably formed in a body by an imprinting process or a roll printing process using a photocurable polymer.

A further aspect of the present invention provides a method of manufacturing a polymer membrane having through-holes, comprising: applying a polymer on any one of a pair of molds for forming a through-hole formation area having a plurality of through-holes formed at a predetermined distance and a support area around the through-hole formation area to be thicker than the through-hole formation area so as to support the through-hole formation area; pressing the one of the pair of molds coated with the polymer with the other of the pair of molds; curing the polymer under a condition that the pair of molds are in contact with each other; and separating the pair of molds from each other.

A still further aspect of the present invention provides a method of manufacturing a polymer membrane having through-holes, comprising: supplying a polymer to a pressing area where a pair of roll molds come into contact with each other, the pair of roll molds for forming a through-hole formation area having a plurality of through-holes formed at a predetermined distance and a support area around the through-hole formation area to be thicker than the through-hole formation area so as to support the through-hole formation area; curing the polymer in the pressing area; and discharging the cured polymer from the pressing area.

In the method of manufacturing the polymer membrane having through-holes according to the present invention, the polymer may be a photocurable polymer, and the pair of molds or the pair of roll molds may comprise a hydrophilic material and the photocurable polymer may comprise a hydrophobic material, or the pair of molds or the pair of roll molds may comprise a hydrophobic material and the photocurable polymer may comprise a hydrophilic material.

A yet further aspect of the present invention provides a method of manufacturing a polymer membrane having through-holes, comprising: applying a photocurable polymer on a mold having protrusions for forming through-holes; pressing the mold coated with the photocurable polymer with a flat pressure plate; curing the photocurable polymer under a condition that the protrusions of the mold are in contact with the pressure plate; and separating the mold and the pressure plate from each other, wherein the mold and the pressure plate comprise a hydrophilic material and the photocurable polymer comprises a hydrophobic material, or the mold and the pressure plate comprise a hydrophobic material and the photocurable polymer comprises a hydrophilic material.

### Advantageous Effects

According to the present invention, a polymer membrane has a multilayer structure including a through-hole formation area and a thick support area, and is thus freestanding because the through-hole formation area can be supported by the support area even when it is remarkably thinned by the formation of very fine through-holes, thereby effectively maintaining the shape of the through-holes and the shape of the membrane without use of a separate substrate.

Also according to the present invention, a method of manufacturing a polymer membrane can prevent the generation of a residual layer upon forming through-holes, and thereby a polymer membrane having fine through-holes can be effectively formed in a body using only a polymer forming process such as an imprinting process or a roll printing process, without additional use of a semiconductor process.

### DESCRIPTION OF DRAWINGS

FIG. 1 illustrates a typical polymer forming process for manufacturing a nanostencil using a polymer;

FIG. 2 illustrates a polymer membrane according to an embodiment of the present invention;

FIG. 3 illustrates a cross-sectional view taken along the line A-A′ of FIG. 2;

FIG. 4 illustrates a polymer membrane according to another embodiment of the present invention;

FIG. 5 illustrates the polymer membrane of FIG. 2 which is inverted;

FIGS. 6 to 8 illustrate a process of manufacturing a polymer membrane according to a first embodiment of the present invention, in order to manufacture the polymer membrane according to the present invention using an imprinting process;

FIGS. 9 to 11 illustrate a process of manufacturing a polymer membrane according to a second embodiment of the present invention, in order to manufacture the polymer membrane according to the present invention using an imprinting process;

FIG. 12 schematically illustrates an apparatus for manufacturing the polymer membrane according to the present invention using a roll printing process; and

FIG. 13 schematically illustrates a process of manufacturing a polymer membrane according to another embodiment of the present invention.

### MODE FOR INVENTION

Hereinafter, a detailed description will be given of embodiments of the present invention with reference to the appended drawings.

The present invention permits a variety of modifications and variations and illustrates specific embodiments thereof in the drawings, which will be specified below. However, the present invention is not intended to limit it to the specific embodiments as disclosed herein, and includes all modifications, equivalents and contents corresponding to the spirit of the present invention defined by the claims.

For the sake of clear description, the thicknesses and sizes of layers, recesses and areas in the drawings are depicted to be exaggerated. Thus, the present invention is not limited to the relative sizes or distances depicted in the drawings.

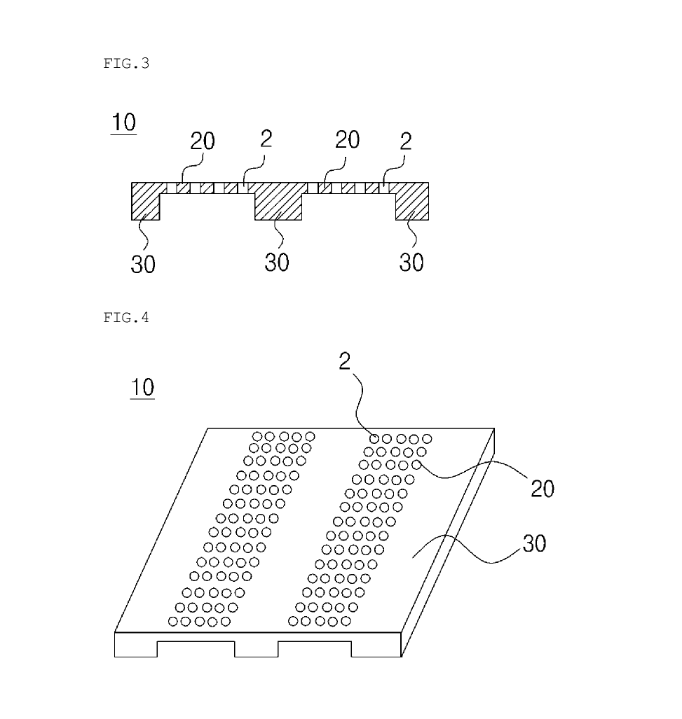

FIG. 2 illustrates a polymer membrane according to an embodiment of the present invention, and FIG. 3 illustrates a cross-sectional view taken along the line A-A′ of FIG. 2.

As illustrated in FIGS. 2 and 3, a polymer membrane 10 according to the present invention includes at least one through-hole formation area 20 having through-holes 12, and a support area 30 for supporting the through-hole formation area 20.

The through-hole formation area 20 has a plurality of through-holes 2 formed at a predetermined distance, and the support area 30 is formed around the through-hole formation area 20 to be thicker than the through-hole formation area 20 so as to support the through-hole formation area 20.

In the polymer membrane 10 according to the present invention, even when the through-hole formation area 20 is very thin due to the formation of through-holes 2 the size of which is approximately in a small range of nanometers, the through-hole formation area 20 may be supported by the support area 30, thus producing an independently freestanding structure even without use of a separate support structure (e.g. a substrate such as a film, silicon, glass, etc.), thereby making it possible to maintain the shape of the through-holes and the shape of the membrane. In order to form fine nanometer-sized through-holes 2 and also a freestanding structure, the polymer membrane 10 according to the present invention has a multilayer structure configured such that the support area 30 having a thickness capable of being freestanding is integrally formed around the through-hole formation area 20.

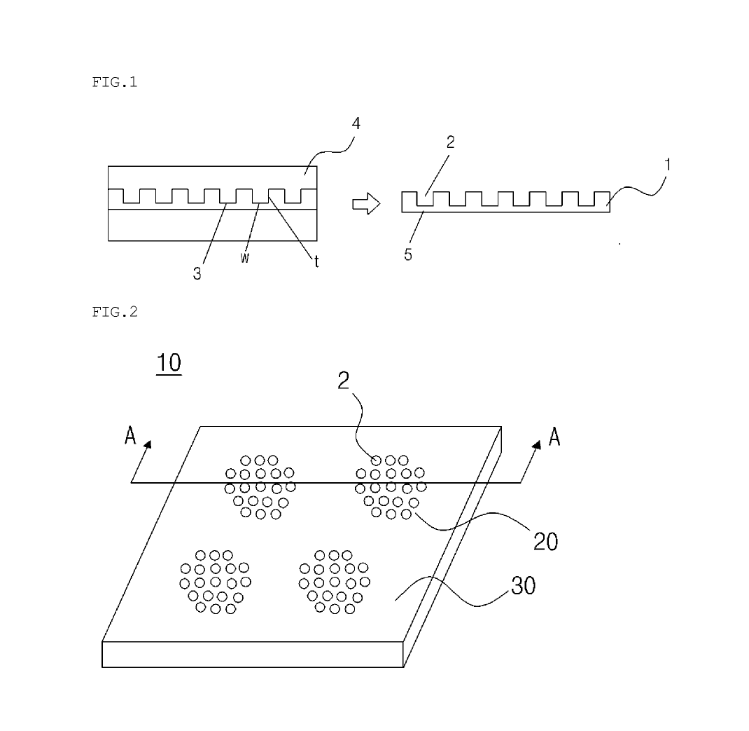

Generally, as a conventional polymer membrane has a thickness varying depending on the size of through-holes 2, the thickness thereof may be decreased with a reduction in the size of the through holes 2, which refers to FIG. 1. As illustrated in FIG. 1, a mold 4 for forming the through-holes 2 has protrusions 3 for forming the through-holes 2, and the width w of the protrusions 3 has a size corresponding to the size of the through-holes 2. As such, the thickness t of the protrusions 3 corresponding to the total thickness of the membrane cannot be set to be much greater than the size of the through-holes 2 to maintain the shape of the protrusions 3. This is because the total thickness of the membrane should be decreased with a reduction in the size of the through-holes 2. Actually, when the size of the through-holes 2 is about 5 μm, the membrane cannot be manufactured so as to have a thickness of 20 μm or more, which is approximately four times the size of the through-holes. In order to enable the polymer membrane alone to be freestanding, it has to have a thickness of about 10 μm or more, and preferably about 20 μm or more, in terms of easy handling thereof. Hence, the typical polymer membrane is limited in that the size of the through-holes 2 should be 5 μm or more under the condition that the freestanding structure is maintained.

Whereas, in the polymer membrane 10 according to the present invention, when the polymer membrane 10 has a multilayer structure having the through-hole formation area 20 and the support area 30, the size of the through-holes 2 may be approximately in a small range of nanometers. Thus, even when the through-hole formation area 20 has a thickness incapable of being freestanding, the support area 30 may be formed so as to have a thickness capable of being freestanding, making it possible to manufacture a polymer membrane which has fine through-holes 2 and is freestanding. Specifically, because the polymer membrane 10 according to the present invention has a multilayer structure, it may have through-holes 2 as small as 5 μm or less while possessing a freestanding structure. As such, the thickness of the through-hole formation area 20 is preferably set to 10 μm or less. As mentioned above, when the through-holes 2 have a size of 5 μm, the size of the through-hole formation area 20 may be set up to 20 μm corresponding to approximately four times the size of the through-holes. However, to maintain the shape of the protrusions 3 of the mold 4 for forming the through-holes 2 and to precisely form the through-holes 2, the protrusions 3 have a width w to thickness t ratio of not more than 2. Briefly, the thickness of the through-hole formation area 20 is preferably set to 10 μm or less. Also, the thickness of the support area 30 is preferably 10 μm or more so as to be freestanding, and is more preferably 20 μm or more so as to be freestanding and to enable easy handling thereof.

In the polymer membrane 10 according to the present invention, the through-holes 2 may have a circular shape, a polygonal shape, etc., but the present invention is not limited thereto. Also, the through-holes 2 formed in the through-hole formation area 20 may be uniformly arranged at a regular distance, or may be non-uniformly arranged at irregular distances, but the present invention is not limited thereto.

Preferably, a plurality of through-hole formation areas are formed at a predetermined distance. As such, the support area 30 is preferably formed around each of the through-hole formation areas 20, as illustrated in FIG. 2.

FIG. 4 illustrates a polymer membrane according to another embodiment of the present invention. As illustrated in FIG. 4, the polymer membrane 10 according to the present invention is configured such that through-hole formation areas 20 are unidirectionally formed long and a support area 30 may be formed between the through-hole formation areas 20. In this case, however, the upper and lower ends of the through-hole formation areas 20 are not supported by the support area 30 as seen in the drawing, and thus, as illustrated in FIG. 2, it is preferred that the support area 30 be formed around each of the through-hole formation areas 20.

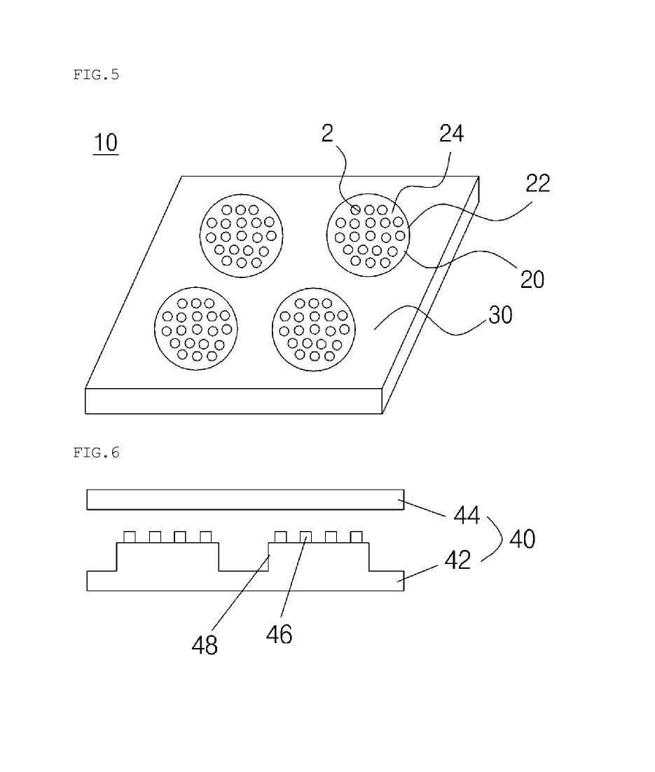

FIG. 5 illustrates the polymer membrane of FIG. 2 which is inverted.

As illustrated in FIG. 5, the through-hole formation areas 20 may be the bottoms 24 of recesses 22 formed on any one side (which is the lower side in FIG. 1 and the upper side in FIG. 5) of the polymer membrane, and a plurality of through-holes 2 may be formed at the bottoms 24 of the recesses 22.

Thus, the polymer membrane 10 according to this embodiment has an independently freestanding structure without need of a separate support structure because the plurality of fine through-holes 2 are formed at the bottoms 24 of the recesses 22 formed on any one side thereof. Specifically, the polymer membrane 10 according to this embodiment is configured such that the total thickness thereof is formed with the support area 30 having a thickness capable of being freestanding, and recesses 22 for forming the through-hole formation areas 20 may be formed at a predetermined distance on portions of the support area 30, and the plurality of through-holes 2 may be formed at the bottoms 24 of the recesses 22. The thickness of the bottoms 24 of the recesses 22 preferably approximates at most two times the size of the through-holes 2 so as to be adapted for the size of the through-holes 2 to be formed. Preferably, the recesses 22 are micrometer-sized, and the through-holes 2 are nanometer-sized, and more preferably, the size of the recesses 22 is 10˜1000 μm, and the size of the through-holes 2 is 5˜1000 nm. In this way, when the size of the recesses 22 is about 10 μm or more, the total thickness of the membrane 10 may be 20 μm or more. As such, even when the through-holes 2 have a size of 1 μm or less, namely, are finely nanometer-sized, the membrane 10 may be freestanding.

As for the pluralities of through-hole formation areas 20 and recesses 22 formed at a predetermined distance on the membrane 10, the distance therebetween may be regular or irregular, but the present invention is not limited thereto. Furthermore, the recesses 22 of the through-hole formation areas 20 may have a circular shape or a polygonal shape, but the present invention is not limited thereto.

Preferably, the polymer membrane 10 according to the present invention is formed in a body by an imprinting process or a roll printing process using a photocurable polymer.

Below is a detailed description of a method of manufacturing the polymer membrane 10 according to the present invention with reference to the drawings.

In the method of manufacturing the polymer membrane 10 according to the present invention, complete through-holes 2 may be integrally formed without a residual layer 5 using only a polymer forming process, such as an imprinting process or a roll printing process. The method of manufacturing the polymer membrane 10 according to the present invention using an imprinting process is first specified with reference to the drawings.

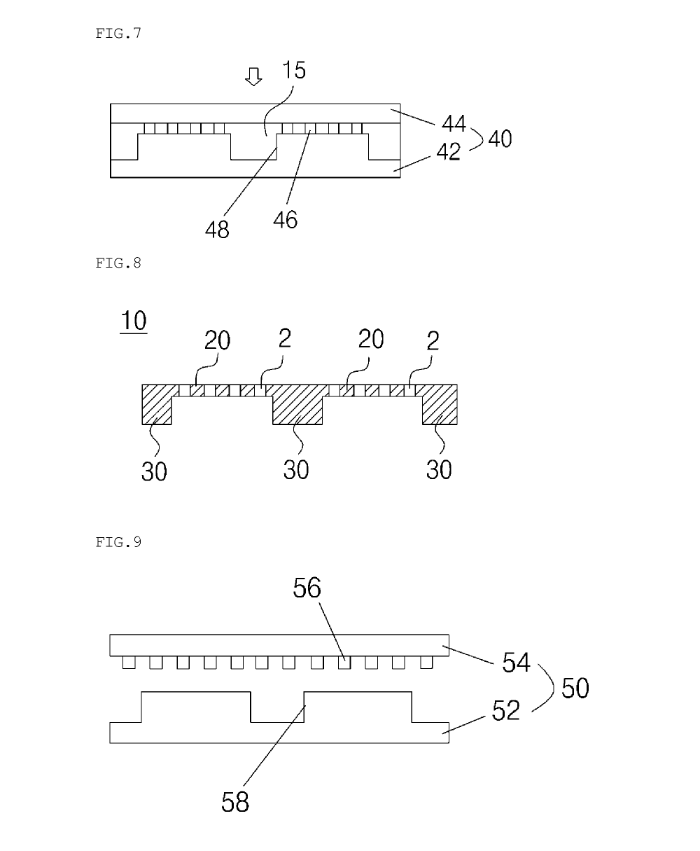

FIGS. 6 to 8 illustrate a process of manufacturing a polymer membrane according to a first embodiment of the present invention, in order to manufacture the polymer membrane according to the present invention using an imprinting process. Specifically, FIG. 6 illustrates a pair of molds for producing a polymer membrane according to the present invention, FIG. 7 illustrates the pair of molds which are pressed in such a manner that of the pair of molds, one is coated with a polymer and then pressed with the other, and FIG. 8 illustrates a polymer membrane obtained by separating the pair of molds from each other.

Referring to FIGS. 6 to 8, the method of manufacturing the polymer membrane according to the first embodiment of the present invention includes applying a polymer 15 on any one 42 of a pair of molds 40 for forming a through-hole formation area 20 having a plurality of through-holes 2 formed at a predetermined distance and a support area 30 formed around the through-hole formation area 20 to be thicker than the through-hole formation area 20 so as to support the through-hole formation area 20, pressing the pair of molds 40 until the one coated with the polymer 15 and the other 44 come into contact with each other, curing the polymer 15 under the condition that the pair of molds 40 are in contact with each other, and separating the pair of molds 40 from each other.

The polymer 15 is preferably a photocurable polymer, and thus curing the polymer 15 may be performed by irradiating UV light under the condition that the pair of molds 40 are in contact with each other between which the polymer 15 is interposed. In this way, when the photocurable polymer 15 is cured under the condition that the pair of molds are in contact with each other, the polymer membrane 10 having the complete through-holes 2 without the residual layer 5 may be formed in a body using only an imprinting process.

Preferably, the pair of molds 40 include a multilayer mold 42 configured such that a plurality of protrusions 46 for forming the through-holes 2 are formed at a predetermined distance on a projecting part 48 for forming the through-hole formation area 20, and a flat mold 44. As such, pressing is carried out until the protrusions 46 of the multilayer mold 42 and the flat mold 44 come into contact with each other, and curing may be performed by curing the photocurable polymer 15 interposed between the protrusions 46 of the multilayer mold 42 and the flat mold 44 which are in contact with each other.

More preferably, any one of the pair of molds 40 and the photocurable polymer 15 comprises a hydrophobic material, and the other comprises a hydrophilic material. For example, the pair of molds 40 may be made of a hydrophilic material such as PUA (polyurethane acrylate, or PMMA: polymethyl methacrylate), and the photocurable polymer 15 may comprise a hydrophobic material such as PFPE (perfluoropolyether). Alternatively, the pair of molds 40 may be made of a hydrophobic material such as PFPE, and the photocurable polymer 15 may comprise any hydrophilic material such as PUA or NOA. As such, the hydrophilic material may be defined as a material in which the contact angle with a water drop is 90° or less.

When the pair of molds 40 and the photocurable polymer 15 comprise the materials having different properties such as the hydrophobic material and the hydrophilic material, the through-holes 2 may be integrally formed in a more complete through-hole shape without the residual layer by virtue of dewetting of the UV curing material.

Specifically, dewetting is a phenomenon varying depending on the stability of a fluid on the surface of a substrate, and typically, a fluid is not maintained in a circular shape or a spherical shape on a substrate having high surface energy but is spread to be thin on a substrate to form a film. As such, as the surface energy of the substrate is gradually decreased, the fluid becomes spherical by itself and exists as a water drop. Hence, when the pair of molds 40 and the photocurable polymer 15 comprise the materials having different properties such as the hydrophobic material and the hydrophilic material, the photocurable polymer 15 may be quickly squeezed out without generation of a residual layer between the protrusions 46 and the projecting part 48 due to instability between the pair of molds 40 while pressing the pair of molds 40 between which the polymer is interposed, thereby forming complete through-holes 2 having no residual layer.

In the multilayer structure of the polymer membrane 10 according to the present invention, when the pair of molds 40 are pressed under the condition that the photocurable polymer 15 is interposed between the pair of molds 40, the polymer may be more quickly squeezed out due to a difference in size between the protrusions 46 and the projecting part 48 and thus may be loaded in the empty space, thus more rapidly and precisely manufacturing the polymer membrane.

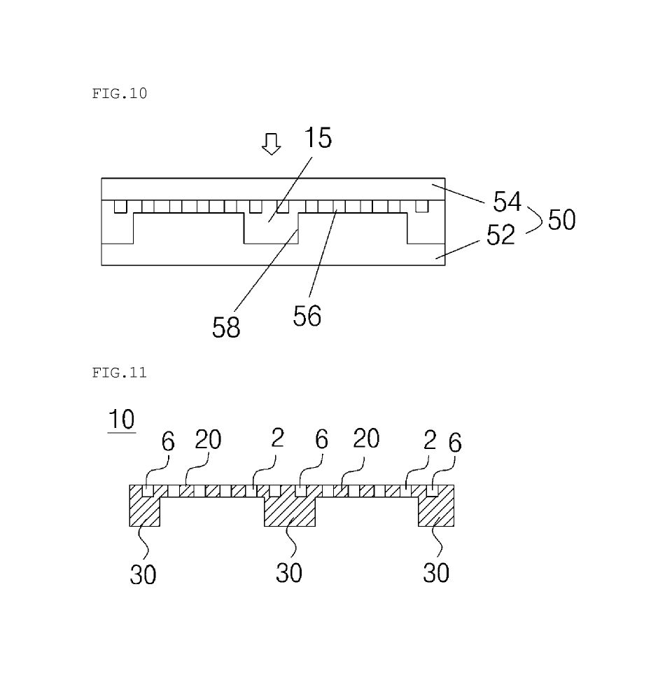

FIGS. 9 to 11 illustrate a process of manufacturing a polymer membrane according to a second embodiment of the present invention, in order to manufacture the polymer membrane according to the present invention using an imprinting process. Specifically, FIG. 9 illustrates a pair of molds according to the second embodiment for producing the polymer membrane according to the present invention, FIG. 10 illustrates the pair of molds which are pressed in such a manner that of the pair of molds, one is coated with a polymer and then pressed with the other, and FIG. 11 illustrates a polymer membrane obtained by separating the pair of molds from each other. Compared to the first embodiment, the method of manufacturing the polymer membrane according to this embodiment adopts the pair of molds having different shapes, which will be described below and in which the other contents quote the detailed description of the first embodiment.

As illustrated in FIGS. 9 to 11, the pair of molds 50 for producing the polymer membrane according to this embodiment includes a first mold 52 having a projecting part 58 for forming a through-hole formation area 20, and a second mold 54 having protrusions 56 for forming through-holes 2. As such, pressing may be performed until the projecting part 58 of the first mold 52 comes into contact with the protrusions 56 of the second mold 54, and curing may be performed by curing the photocurable polymer 15 under the condition that the projecting part 58 of the first mold 52 is in contact with the protrusions 56 of the second mold 54.

In the method of manufacturing the polymer membrane according to this embodiment, as illustrated in FIG. 11, grooves 6 corresponding to the size of the through-holes 2 may be formed on the upper side of the support area 30, and thus the protrusions 56 of the second mold 54 are preferably formed on only an area corresponding to the projecting part 58 of the first mold 52. Furthermore, pressing the first mold 52 and the second mold 54 is preferably carried out under the condition that the protrusions 56 and the projecting part 58 are aligned so as to correspond to each other.

Meanwhile, the method of manufacturing the polymer membrane according to the present invention may be implemented using a roll printing process, and is specified below with reference to the corresponding drawing.

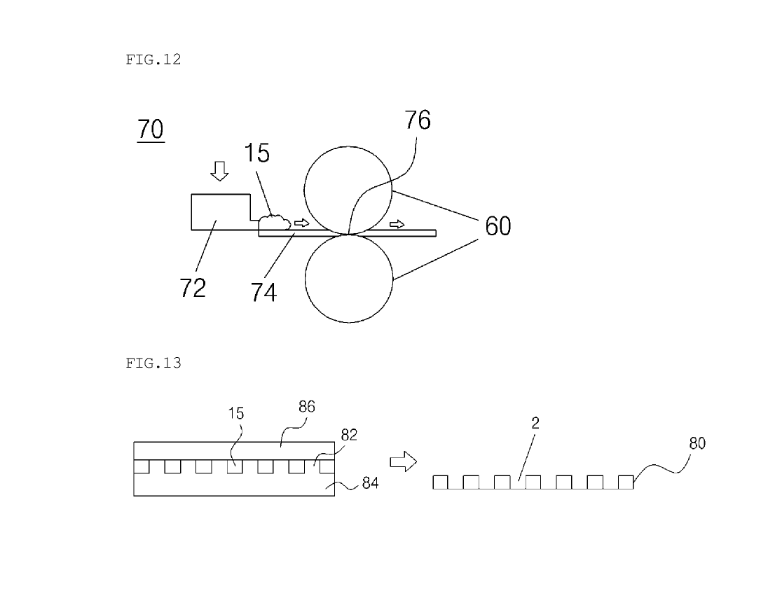

FIG. 12 schematically illustrates a roll printing apparatus for manufacturing the polymer membrane according to the present invention using a roll printing process.

As illustrated in FIG. 12, the roll printing apparatus 70 for manufacturing the polymer membrane according to this embodiment using a roll printing process includes a pair of roll molds 60 that rotate while coming into contact with each other, a storage unit 72 in which a photocurable polymer 15 in a liquid phase is stored, a pressing unit (not shown) for discharging the photocurable polymer 15 from the storage unit 72 by pressing, and a transfer unit 74 for transferring the discharged photocurable polymer 15.

The method of manufacturing the polymer membrane according to this embodiment using the roll printing apparatus 70 includes supporting a photocurable polymer 15 to a pressing area 76 where a pair of roll molds 60 come into contact with each other such that a through-hole formation area 20 having a plurality of through-holes 2 formed at a predetermined distance and a support area 30 formed around the through-hole formation area 20 to be thicker than the through-hole formation area 20 so as to support the through-hole formation area 20 are formed in a body, curing the photocurable polymer 15 in the pressing area 76, and discharging the cured polymer from the pressing area 76. The photocurable polymer 15 may be transferred by means of a roller that is the transfer unit 74 as in a general roll printing process, but the present invention is not limited thereto.

Although not shown in the drawing, as in the first and second embodiments, the pair of roll molds 60 may include a multilayer roll mold configured such that protrusions for forming the through-holes 2 are formed at a predetermined distance on a projecting part for forming the through-hole formation area 20, and a flat roll mold. As such, curing is preferably performed by curing the photocurable polymer 15 under the condition that the protrusions of the multilayer roll mold are in contact with the flat roll mold.

Alternatively, the pair of roll molds 60 may include a first roll mold having a projecting part for forming the through-hole formation area 20, and a second roll mold having protrusions for forming the through-holes 2. As such, curing is preferably performed by curing the polymer under the condition that the projecting part of the first roll mold is in contact with the protrusions of the second roll mold.

In the method of manufacturing the polymer membrane according to the present invention as mentioned above, a polymer membrane having a multilayer structure such as the polymer membrane 10 according to the present invention may be manufactured such that the complete through-holes 2 may be integrally formed without the residual layer 5 using only an imprinting process or a roll printing process. Alternatively, a polymer membrane having a typical monolayer structure instead of the multilayer structure may be manufactured such that complete through-holes 2 may be integrally formed without a residual layer 5.

FIG. 13 schematically illustrates a process of manufacturing a polymer membrane according to another embodiment of the present invention, wherein the polymer membrane 80 having not a multilayer structure but a monolayer structure may be manufactured such that complete through-holes may be integrally formed without a residual layer.

As illustrated in FIG. 13, the method of manufacturing the polymer membrane 80 according to this embodiment includes applying a photocurable polymer 15 on a mold 84 having protrusions 82 for forming the through-holes 2, pressing the mold 84 coated with the photocurable polymer 15 with a flat pressure plate 86, curing the photocurable polymer 15 under the condition that the protrusions 82 of the mold 84 are in contact with the pressure plate 86, and separating the mold 84 and the pressure plate 86 from each other. Thereby, the polymer membrane 80 having the through-holes 2 with a monolayer structure may be manufactured such that the complete through-holes 2 may be integrally formed without the residual layer using only a polymer process.

Preferably, the mold 84 and the pressure plate 86 are made of a hydrophilic material, and the photocurable polymer 15 comprises a hydrophobic material, or the mold 84 and the pressure plate 86 are made of a hydrophobic material, and the photocurable polymer 15 comprises a hydrophilic material. When the mold 84 and the pressure plate 86 and the photocurable polymer 15 comprise the materials having different properties such as the hydrophobic material and the hydrophilic material in this way, the through-holes 2 may be integrally formed in a more complete through-hole shape without the residual layer, by virtue of dewetting of the UV curing material.

As described hereinbefore, in the polymer membrane having through-holes and the manufacturing method thereof according to the present invention, the freestanding polymer membrane can be configured to have fine through-holes and to be capable of maintaining a shape by itself without use of a separate substrate, and the method of the invention enables the polymer membrane having through-holes to be manufactured such that complete through-holes are integrally formed without a residual layer using only a polymer process, and embodiments thereof may be variously modified. Therefore, the present invention is not limited to the embodiments disclosed herein, and those having ordinary knowledge in the art to which the present invention belongs will appreciate that all modifications fall within the scope of the present invention.

1. A freestanding polymer membrane having through-holes, comprising at least one through-hole formation area having a plurality of through-holes formed at a predetermined distance and a support area formed around the through-hole formation area to be thicker than the through-hole formation area so as to support the through-hole formation area, the polymer membrane being freestanding without use of a separate substrate.

2. The freestanding polymer membrane of claim 1, wherein the through-hole formation area is a bottom of a recess formed on any one side of the polymer membrane.

3. The freestanding polymer membrane of claim 1, wherein the at least one through-hole formation area comprises a plurality of through-hole formation areas formed at a predetermined distance, and the support area is formed around each of the through-hole formation areas.

4. The freestanding polymer membrane of claim 1, wherein the membrane is formed in a body by an imprinting process or a roll printing process using a photocurable polymer.

5. A freestanding polymer membrane having through-holes, configured such that a plurality of fine nanometer-sized through-holes are formed at a bottom of at least one recess on a micrometer scale on any one side of the polymer membrane, the polymer membrane being freestanding without use of a separate support structure.

6. The freestanding polymer membrane of claim 5, wherein the at least one recess comprises a plurality of recesses formed at a predetermined distance.

7. A method of manufacturing a polymer membrane having through-holes, comprising:
applying a polymer on any one of a pair of molds for forming a through-hole formation area having a plurality of through-holes formed at a predetermined distance and a support area around the through-hole formation area to be thicker than the through-hole formation area so as to support the through-hole formation area such that the through-hole formation area and the support area are formed in a body;
pressing the one of the pair of molds coated with the polymer with the other of the pair of molds;
curing the polymer under a condition that the pair of molds are in contact with each other; and
separating the pair of molds from each other.

8. The method of claim 7, wherein the pair of molds include a multilayer mold configured such that a plurality of protrusions for forming the through-holes are formed at a predetermined distance on a projecting part for forming the through-hole formation area, and a flat mold, and curing is performed by curing the polymer under the condition that the protrusions of the multilayer mold are in contact with the flat mold.

9. The method of claim 7, wherein the pair of molds include a first mold having a projecting part for forming the through-hole formation area, and a second mold having protrusions for forming the through-holes, and curing is performed by curing the polymer under the condition that the projecting part of the first mold is in contact with the protrusions of the second mold.

10. The method of claim 7, wherein the polymer is a photocurable polymer, and any one of the photocurable polymer and the pair of molds comprise a hydrophobic material, and the other comprises a hydrophilic material.

11. (canceled)

12. (canceled)
